(19) United States
(12) Patent Application Publication
(10) Pub. No.: US 2023/0264287 A1
(43) Pub. Date: Aug. 24, 2023

(54) JOINING APPARATUS

(71) Applicant: NEWFREY LLC, New Britain, CT (US)

(72) Inventors: Christoph EISENBERG, Giessen (DE); Bettina FISCHERMANNS, Giessen (DE); Nicolas NAB, Giessen (DE); Manuel SCHNEIDER, Giessen (DE); Alexander SCHUG, Giessen (DE)

(21) Appl. No.: 17/815,763

(22) Filed: Jul. 28, 2022

(30) Foreign Application Priority Data
Feb. 22, 2022 (DE) 202022100994.5

(51) Int. Cl. B23K 9/235; B23K 37/02

(52) U.S. Cl. CPC B23K 9/235; B23K 37/0211

(57) ABSTRACT

A joining apparatus for the joining of a joining element to a workpiece on a joining surface, the joining apparatus comprising: a joining head that defines a joining axis; a cleaning device for cleaning the joining surface; and a drive unit for moving the cleaning device in relation to the joining head between a waiting position and a cleaning position. The waiting position axially rearward and transversely spaced from a holding device forwardmost on the joining head; and the cleaning position axially forward and transversely closer to the holding device

### CROSS-REFERENCE TO RELATED APPLICATIONS

This application claims priority from German Utility Model Application No. 202022100994.5, filed Feb. 22, 2022, the disclosures of which are incorporated herein by reference in their entirety.

### BACKGROUND OF THE INVENTION

The present invention relates to a joining apparatus for the joining of joining elements to components, in particular for stud welding or bonding, the joining apparatus comprising a joining arrangement that defines a joining arrangement, and a cleaning device for cleaning a joining surface.

Such a joining apparatus is known from the document DE 10 2016 125 599 A1. The joining apparatus known from this document is shown in FIG. 9. The joining apparatus of FIG. 9 has a joining head which is moveable freely in space, for example by means of a robot, wherein the joining head in this case is preferably mounted on an arm of the robot. A carriage is preferably moveable along a joining axis on the joining head. The maximum stroke of the carriage is preferably greater than a maximum joining stroke.

A holding device for holding a joining element is arranged on the carriage. The joining element can be designed, for example, as a stud, with a shaft portion not described in greater detail and a flange portion not described in greater detail, wherein a first joining surface is formed on a side of the flange portion facing away from the shaft portion. The joining element is preferably made of steel or aluminium or an alloy thereof.

By means of the joining apparatus, the joining element can be joined to a component such as a metal sheet, wherein the component is preferably likewise made of steel, of aluminium or of an alloy thereof.

A second joining surface is formed on the component and has a diameter approximately equal to the diameter of the flange portion of the joining element.

A coating can be formed on the joining surface and can be formed from release agents or from waxes, oils, polysiloxanes, hydrocarbons, polymers, etc.

The joining apparatus is particularly formed as a stud welding device, but can also be formed as a stud bonding device.

The joining apparatus includes a cleaning device, by means of which the second joining surface can be cleaned before the joining process is performed. The cleaning device is preferably designed to direct a cleaning medium onto the second joining surface, more specifically along an application axis which is oriented at an angle with respect to the second joining surface. The angle can, for example, lie in a range from 30° to 90°, in particular in a range from 30° to 85°.

The cleaning device is attached to the joining head.

Furthermore, the joining apparatus can include a detection device, which can detect a condition of the second joining surface and/or a surface coating on the second joining surface. In particular, the detection device is designed to detect a characteristic variable of the component.

In order to create high-quality joints, in particular to produce consistent joints, it is preferred if each joining surface is first examined by means of the detection device before a joining process is performed, wherein a characteristic variable detected as a result is then evaluated. Depending on this, a decision can be made as to whether a joining process can be carried out immediately afterwards or whether it is sensible or advisable to perform a cleaning process beforehand by means of the cleaning device.

The cleaning device can be a plasma gas cleaning device, a TIG arc cleaning device or a snow jet cleaning device, as described in DE 10 2016 125 599 A1.

For example, a distance between a plasma gas nozzle and the joining surface can be set in a range of from 2 mm to 25 mm.

### BRIEF SUMMARY OF THE INVENTION

Against this background, it is an object of the invention to provide an improved joining apparatus which, in particular, enables optimised positioning of the cleaning device in relation to the joining surface to be cleaned.

The above object is solved by a joining apparatus for the joining of joining elements to components, in particular for stud welding or bonding, the joining apparatus comprising a joining arrangement, which defines a joining axis, comprising a cleaning device for cleaning a joining surface, and comprising a drive unit for moving the cleaning device in relation to the joining arrangement between a waiting position and a cleaning position.

The drive unit makes it possible to move the cleaning device into a waiting position with respect to the joining arrangement in a normal operating state. Joining processes can therefore be carried out undisturbed by the cleaning device. Furthermore, it is possible by means of the drive unit to move the cleaning device into a cleaning position, more specifically with respect to the joining arrangement. This makes it possible to position the cleaning device optimally in relation to the joining surface to be cleaned. This also reduces the spatial requirement.

The object is thus solved in full.

It is of particular advantage if the drive unit is fixed to the joining unit.

As a result of this, the joining arrangement, which is formed as a joining head, for example, can be integrated with the drive unit and the cleaning device.

According to a further preferred embodiment, the drive unit comprises a linear drive.

A linear drive is comparatively easy to implement. Furthermore, the drive unit can be implemented with a single actuator. Complex motion mechanics are not necessary.

It is of particular advantage if the linear drive comprises a pneumatic cylinder.

In this case, the cleaning device can be moved precisely back and forth between the cleaning position and the waiting position. The pneumatic cylinder is preferably a double-acting pneumatic cylinder, but can also be a single-acting pneumatic cylinder. The drive unit preferably has corresponding stops for the waiting position and the cleaning position.

According to a further embodiment, the cleaning device comprises a housing that is coupled to the linear drive.

The coupling can be a rigid coupling, but can also be an articulated coupling. The housing of the cleaning device is consequently displaced between the waiting position and the cleaning position. An applicator can be fixed to the housing, by means of which applicator a cleaning medium can be directed towards the joining surface. The applicator, which can be formed as a nozzle, for example, has an applicator tip which, in the waiting position, is positioned away from the joining axis and a holding device of the joining arrangement. In the cleaning position, however, the applicator tip can be arranged relatively close to the joining axis and can be arranged in front of the holding device of the joining arrangement in the direction of the joining axis.

Furthermore, it is advantageous if the drive unit comprises a constraining guide for the cleaning device, wherein the cleaning device is moveable on a defined path between the waiting position and the cleaning position by means of the constraining guide.

The constraining guide can be implemented, for example, by a gate, which can also define stops for a linear drive if necessary.

Here, it is preferable if the constraining guide is designed in such a way that the cleaning device is guided parallel to the joining axis, at least in some portions.

For example, this may cause the applicator tip to be displaced in the longitudinal direction from a position behind a holding device of the joining arrangement to a position in front of the holding device.

According to a further preferred embodiment, the constraining guide is designed in such a way that the cleaning device is guided transversely to the joining axis, at least in some portions.

This embodiment makes it possible to arrange the applicator tip closer to the joining axis in the cleaning position than in the waiting position.

Furthermore, it is advantageous if the constraining guide is designed in such a way that, starting from the waiting position, the cleaning device is first offset or guided substantially parallel to the joining axis, then transversely to the joining axis, wherein, after the transverse offset, the cleaning device is preferably guided again substantially parallel to the joining axis towards the cleaning position.

This measure makes it possible to implement the ideal positioning of the applicator tip while suitably avoiding interfering contours of the joining arrangement.

It is further advantageous if the constraining guide comprises a gate slot, which is connected to the joining arrangement, wherein the constraining guide further comprises a gate follower arrangement, which is connected to a housing of the cleaning device and engages the gate slot.

In this embodiment, longitudinal ends of the gate slot are preferably formed as stops for a linear drive and define the waiting position and the cleaning position.

According to another preferred embodiment, the gate slot comprises a first longitudinal portion and a bend portion.

By means of the first longitudinal portion, it is possible, for example, to move the cleaning device substantially parallel to the joining axis. By means of the bend portion, for example, it is possible to move the cleaning device substantially transversely to the joining axis.

According to another preferred embodiment, the gate slot further comprises a second longitudinal portion, wherein the bend portion is disposed between the first and second longitudinal portion.

According to another preferred embodiment, the gate follower arrangement comprises two gate followers spaced apart from one another in a direction substantially parallel to the joining axis and engaging the gate slot.

By way of this measure, an exact guidance of the housing of the cleaning device in relation to the slot can be implemented.

The gate followers can be implemented, for example, by pins.

However, it is preferable if the gate followers are formed by rollers or bearings. This can reduce the friction.

According to a preferred embodiment, a spacing of the gate followers is less than a longitudinal extent of a first longitudinal portion of the gate slot.

This makes it possible to move the cleaning device over a certain longitudinal extent parallel to the gate slot.

Further, it is advantageous if a spacing of the gate followers is greater than a longitudinal extent of a bend portion of the gate slot and/or is greater than a longitudinal extent of a second longitudinal portion of the gate slot.

In this embodiment, it is possible that, during the transition from the waiting position to the cleaning position, only one (the front one) of the gate followers enters the bend portion and lastly, if necessary, the second longitudinal portion, while the other (the rear) gate follower remains in the first longitudinal portion.

This can be used to set up a kind of pivoting movement around the axis of the rear gate follower, which is superimposed on the longitudinal movement of both gate followers.

This makes it possible to move the applicator tip closer to the joining axis.

The cleaning device preferably includes a plasma gas cleaning device.

With the disclosed joining apparatus, it is possible to implement a small interference contour in the joining region (in this case, the cleaning device is in the waiting position). At the same time, it is possible to meet the requirements of the cleaning process in respect of a maximum cleaning distance from the joining surface. This can be achieved in particular by moving an applicator tip not only in the longitudinal direction, but also in a direction transverse to the joining axis.

It is understood that the drive unit can preferably be actuated independently of any joining carriage or other joining movement, even if the cleaning device and the drive unit are arranged on a common joining head.

The defined path along which the applicator is moved in relation to the joining axis can ensure that the applicator (for example a torch) does not collide with a part of the joining arrangement, such as a shielding gas mouthpiece, from a movement towards the joining surface.

Preferably, the drive unit is a fully linear drive, for example by means of a pneumatic cylinder controlled by a valve. Nevertheless, the movement of the cleaning device can be implemented both along the joining axis and towards the joining axis.

The cleaning device, which can be used in the present case in conjunction with the joining arrangement, can be any cleaning device. In particular, it can be a cleaning device as described in the above-described document DE 10 2016 125 599 A1. The content of the disclosure of that document is therefore incorporated herein by reference.

It is understood that the above-described features and those yet to be explained below are usable not only in the described combinations, but also in other combinations or on their own, without departing from the scope of the present invention.

### BRIEF DESCRIPTION OF THE DRAWINGS

Exemplary embodiments of the invention are shown in the drawing and will be explained in more detail in the following description. In the drawing:

FIG. 1 shows a perspective view of a joining apparatus.

FIG. 2 shows the joining apparatus of FIG. 1 in a waiting position.

FIG. 3 shows the joining apparatus of FIG. 1 in a first position between the waiting position and a cleaning position.

FIG. 4 shows the joining apparatus of FIG. 1 in a second position between the waiting position and the cleaning position.

FIG. 5 shows the joining apparatus of FIG. 1 in a third position between the waiting position and the cleaning position.

FIG. 6 shows the joining apparatus of FIG. 1 in a fourth position between the waiting position and the cleaning position.

FIG. 7 the joining apparatus of FIG. 1 in the cleaning position.

FIG. 8 a front view along the joining axis of the joining apparatus of FIG. 1.

FIG. 9 a joining apparatus according to the prior art.

### DETAILED DESCRIPTION OF THE PREFERRED EMBODIMENTS

In FIG. 1, a joining apparatus is shown in perspective and is denoted generally by 10.

The joining apparatus 10 includes a joining arrangement 12 (joining head), which is guided, for example, by means of a robot 14 and for this purpose is fixed to an arm 16 of the robot 14.

A carriage 18 is moveable on the joining arrangement 12 along a joining axis 20. The carriage 18 includes a holding device 22, which is designed to hold a joining element 24 (shown schematically in FIG. 1). A mouthpiece 25 is also provided. The mouthpiece 25 is arranged around the holding device 22. The holding device 22 can move along the joining axis 20 independently of the mouthpiece 25.

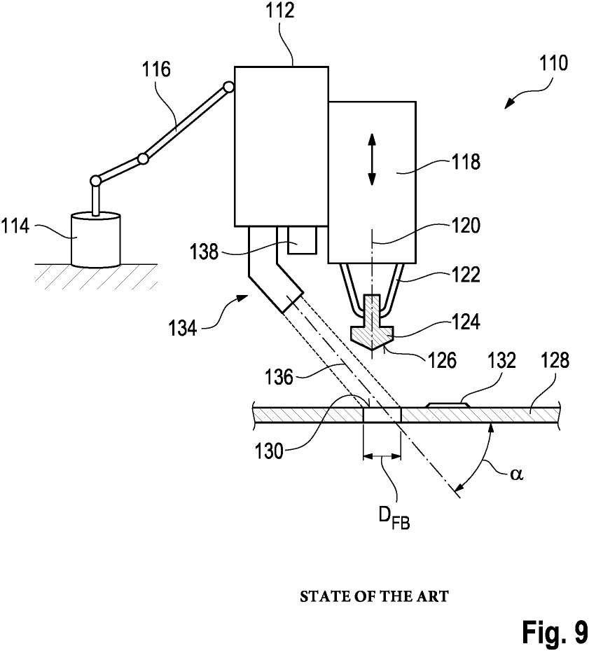

For example, the joining arrangement 12 can be in the form of a stud welding arrangement. In an exemplary stud welding process, the joining arrangement 12 is positioned above a component. The carriage is then actuated so that the joining element 24 held in the holding device 22 contacts the component (see FIG. 9). The mouthpiece 25 also contacts the component. A pilot current is then switched on and flows over the component and the joining element. The joining element is then lifted off so that an electric arc is drawn (the mouthpiece 25 remains in contact with the component during this step). The current is then increased to melt the oppositely arranged joining surfaces (see FIG. 9). The stud is then lowered back onto the component by means of the carriage. The current is switched off. The mixed melts of the joining element and the component cool down and the joining element (stud) is welded to the component.

In some cases, it is useful to clean the joining surface of the component (see reference sign 130 in FIG. 9) before such a joining operation, especially if the joining surface is covered with a coating.

To this end, the joining apparatus 10 comprises a cleaning device 34 attached to the joining arrangement 12.

The cleaning device 34 defines an application axis 36 oriented at an angle α with respect to the joining axis 20. However, the application axis 36 can also be oriented parallel to the joining axis 20.

Furthermore, a detection device 38 is fixed to the joining arrangement 12 and can, for example, detect a surface condition of the component in a manner similar to that described with respect to FIG. 9. The detection device 38, however, is provided optionally.

The cleaning device 34 includes a nozzle-type applicator 40 having an applicator tip 42. The applicator 40 is, for example, a plasma nozzle (or a plasma torch).

The joining apparatus 10 further includes a drive unit 44 for moving the cleaning device 34 between a waiting position WP and a cleaning position RP. The drive unit 44 includes a linear drive 46, which can be formed in particular by a pneumatic cylinder 47.

The cleaning device 34 includes a housing 48, which is oriented generally parallel to the longitudinal axis 20, with the applicator 40 and applicator tip 42 disposed at the forward end of said housing.

The housing 48 is displaceable between the waiting position and the cleaning position by means of a constraining guide 50 (gate). For this purpose, the housing 48 is coupled to the pneumatic cylinder 47, either rigidly or in an articulated fashion.

The constraining guide 50 includes a gate slot 52, which is formed on a component of the drive unit 44 that is fixed to the joining arrangement 12. The gate slot 52 extends generally parallel to the joining axis 20.

A first gate follower 54 and a second gate follower 54 are fixed to the housing 48, axially spaced apart from one another, and each engage in the gate slot 52.

This allows the housing 48 of the cleaning device 34 to be forcibly guided along the gate slot 52.

The cleaning device 34 is usually in the waiting position WP shown in FIG. 1. This means that the applicator tip is arranged comparatively behind the holding device 22 and away from the joining axis 20, so that the cleaning device 34 does not interfere with the actual joining process.

If the joining surface of the component onto which the joining element 24 is to be joined is to be cleaned, the cleaning device 34 is moved, before the joining process, into the cleaning position, in which the applicator tip is guided in the axial direction in front of the holding device 22 (and in front of the mouthpiece 25), and in particular also closer to the joining axis 20.

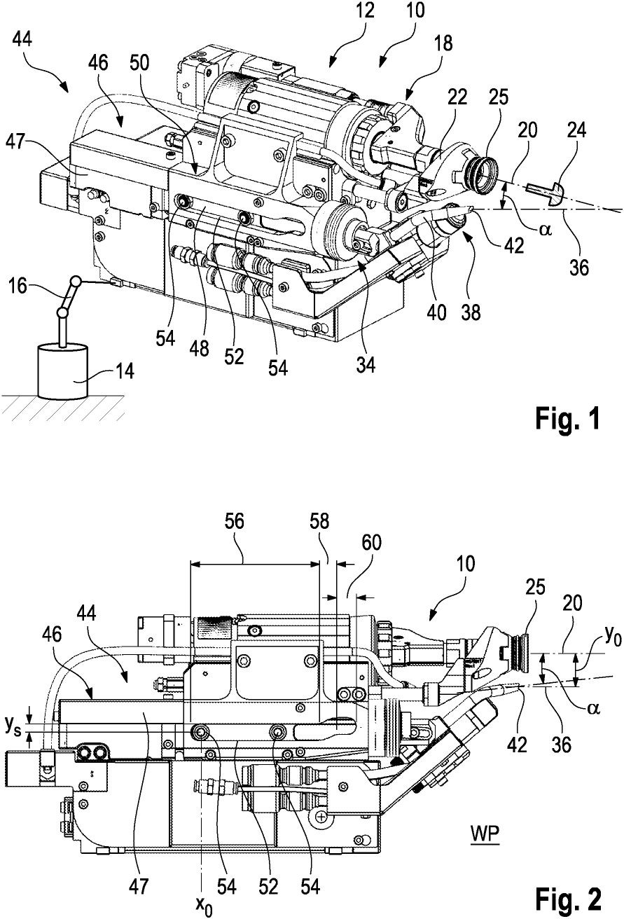

This transition from the waiting position WP to the cleaning position RP is shown in FIGS. 2 to 7.

FIG. 2 shows the waiting position WP. In this position of the cleaning device, the applicator tip 42 is a distance y₀ away from the joining axis 20. The value of y₀ can lie in a range of from 1 cm to 8 cm, for example.

In FIG. 2, the applicator tip 42 is additionally positioned axially behind the front end of the mouthpiece 25 of the joining arrangement 12. The mouthpiece 25 is often placed on the component during the joining process, for example to introduce a protective gas or the like.

FIG. 2 further shows that the gate slot 52 has a first longitudinal portion 56, a bend portion 58, and a second longitudinal portion 60.

In the waiting position WP, the rear gate follower 54 abuts a rear end of the first longitudinal portion 56. The front gate follower 54 (the right-hand gate follower in FIG. 2) lies inside the first longitudinal portion 56. The bend portion is formed in the manner of an offset and connects the first longitudinal portion 56 and the second longitudinal portion 60. The bend portion 58 defines an offset value yₛ in the transverse direction between the first longitudinal portion 56 and the second longitudinal portion 60. The offset value yₛ is less than or equal to the value of y₀.

In FIG. 2, the waiting position WP is shown, in which the rear gate follower 54 is located at the rear end of the gate slot 52, more specifically in a position x₀.

The bend portion 58 has an axial extent that is smaller than the axial extent of the first longitudinal portion 56. Similarly, the second longitudinal portion 60 has a longitudinal extent that is smaller than that of the first longitudinal portion 56. The ratio of the longitudinal extents of the longitudinal portions 56, 60 may, for example, be in a range from 2:1 to 8:1.

The bend portion 58 is approximately as long in the axial direction as the second longitudinal portion 60.

Starting from the waiting position WP of FIG. 2, the linear drive 46 is controlled to displace the housing 48, specifically along a defined path determined by the constraining guide 50.

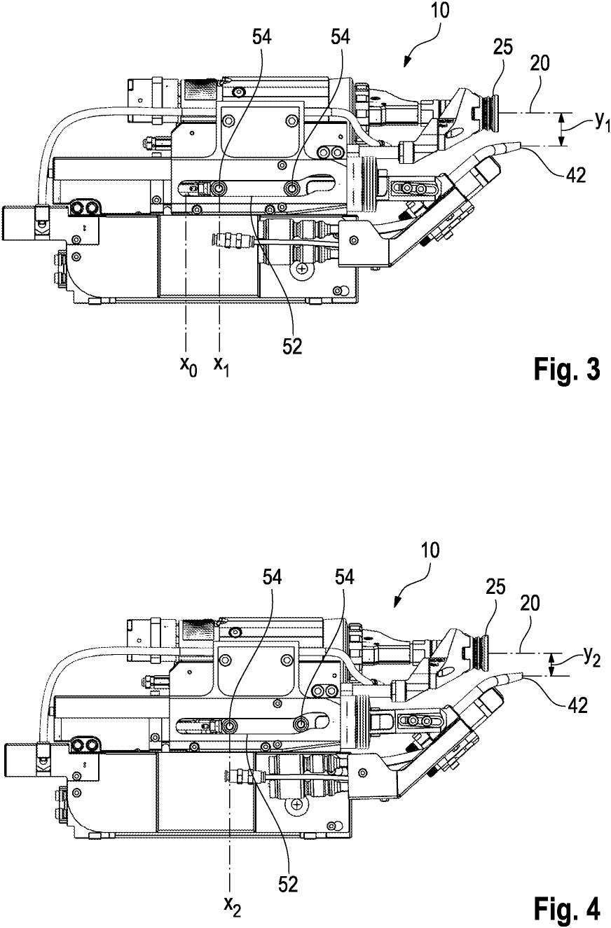

In FIG. 3, a first position x₁ is shown, in which the rear gate follower 54 has moved away from the initial position x₀. The front gate follower 54 is still located within the first longitudinal portion 56. Consequently, the cleaning device 34 is displaced substantially parallel to the joining axis 20 in this first phase. The distance y₁ shown in FIG. 3 between the applicator tip 42 and the joining axis 20 is therefore substantially equal to the distance y₀ shown in FIG. 2. In FIG. 3, the applicator tip 42 is positioned in a position in front of the mouthpiece 25.

FIG. 4 shows a subsequent position, in which the rear gate follower 54 has reached a position x₂. The front gate follower 54 has entered the bend portion 58. Consequently, a distance y₂ is established between the applicator tip 42 and the joining axis 20 and is preferably smaller than the distance y₀.

In FIG. 4, the applicator tip is positioned even further forward of the mouthpiece 25.

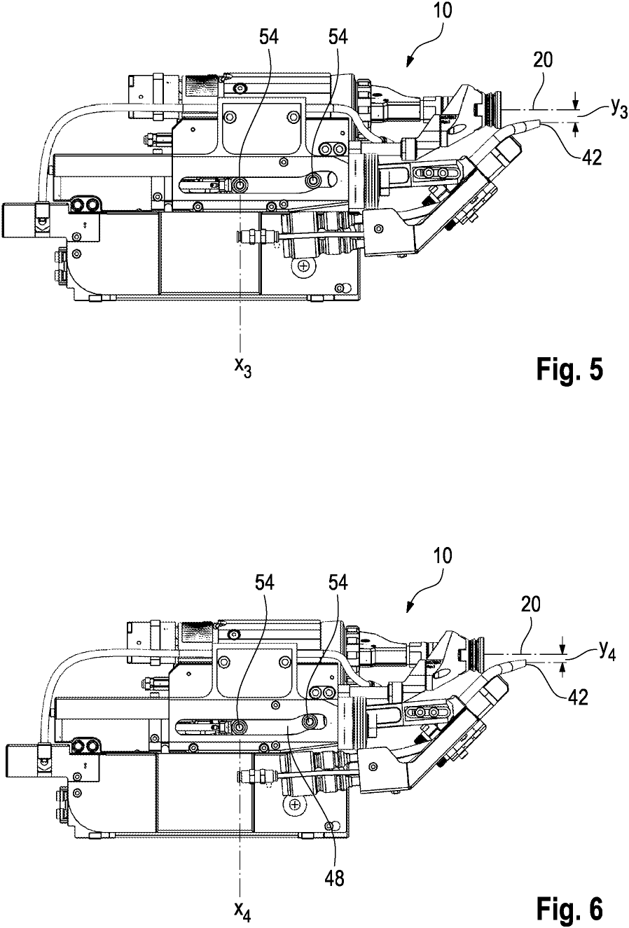

In FIG. 5, a subsequent position x₃ is shown, in which the front gate follower 54 is still located in the bend portion 58. It can be seen that the applicator tip 42 has been moved even closer to the joining axis 20 (y₃ smaller than y₂).

In FIG. 6, a position is shown in which the front gate follower 54 has reached the second longitudinal portion 60, i.e. has left the bend portion 58.

Here, the distance between the applicator tip 42 and the joining axis 20 is further reduced to a value y₄, which is smaller than y₃.

The rear gate follower 54 is still located within the first longitudinal portion 56 in an axial position x₄.

Consequently, as the front gate follower 54 moves within the bend portion 58, the housing 48 of the cleaning device 34 has undergone a form of pivoting movement around the rear gate follower 54, which is superimposed on the longitudinal movement.

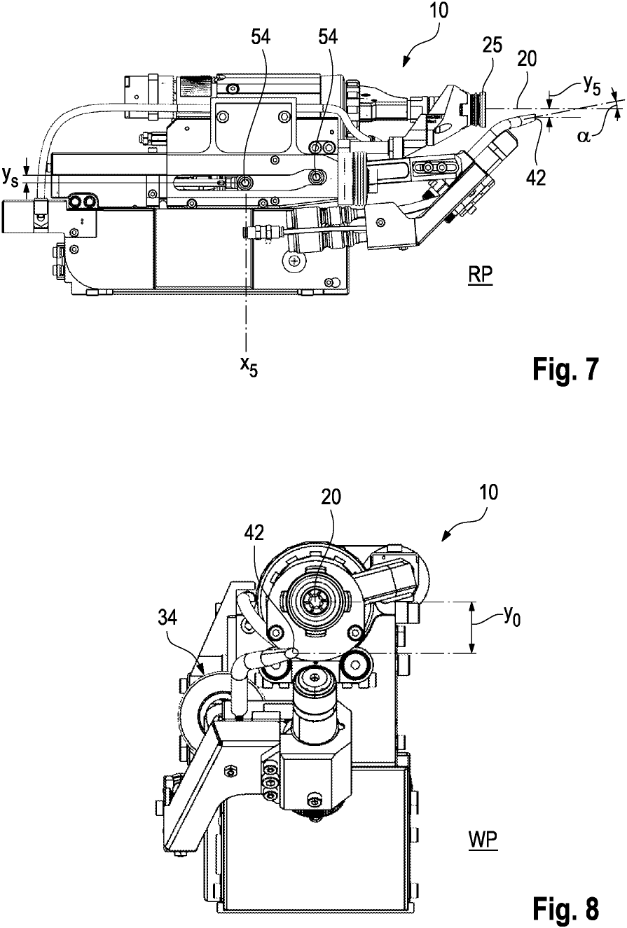

In FIG. 7, the cleaning position RP is shown, in which the front gate follower 54 is located at the end of the second longitudinal portion 60, i.e. has abutted against the front end of the gate slot 52. Here, a distance y₅ is still established between the applicator tip 42 and the joining axis 20 and is substantially equal to the distance y₄, since the front gate follower 54 has moved substantially along the second longitudinal portion between the illustration of FIG. 6 and the illustration of FIG. 7.

In the cleaning position RP shown in FIG. 7, it is possible to selectively apply a cleaning medium by means of the applicator 40 to a joining surface oriented centrally relative to the joining axis 20, more specifically to apply a cleaning medium preferably obliquely at an angle α which can be less than or equal to 90°, in this case less than 90°. The cleaning medium is, for example, plasma. The applicator 40 shoots a plasma jet onto the surface to be cleaned.

Consequently, for a joining process, it is first possible to position the joining axis 20 of the joining arrangement centrally above the joining surface of the component (reference sign 130 in FIG. 9), for example by means of a robot. Subsequently, the cleaning device 34 can first be moved from the waiting position WP into the cleaning position RP. Then, the cleaning process can be carried out. The cleaning device can then be retracted back into the waiting position WP. The joining process described above can then be carried out preferably solely by means of the carriage. Consequently, a repositioning of the joining arrangement is not absolutely necessary after the cleaning process.

FIG. 8 shows a plan view of the joining apparatus 10 in the waiting position WP, in which it can be seen that the applicator tip 42 is spaced apart from the joining axis 20 by the distance y₀ in the transverse direction.

LIST OF REFERENCE SIGNS:

| | |
|---|---|
| 10 | joining apparatus |
| 12 | joining arrangement / joining head |
| 14 | robot |
| 16 | arm |
| 18 | carriage |
| 20 | joining axis |
| 22 | holding device |
| 24 | joining element |
| 25 | mouthpiece |
| 34 | cleaning device |
| 36 | application axis |
| 38 | detection device |
| 40 | applicator (nozzle) |
| 42 | applicator tip |
| 44 | drive unit |
| 46 | linear drive |
| 47 | pneumatic cylinder |
| 48 | cleaning device housing |
| 50 | constraining guide / gate |
| 52 | gate slot |
| 54 | gate follower / rollers |
| 56 | first longitudinal portion |
| 58 | bending portion |
| 60 | second longitudinal portion |
| 110 | joining apparatus |
| 112 | joining head |
| 114 | robot |
| 116 | arm |
| 118 | carriage |
| 120 | joining axis |
| 122 | holding device |
| 124 | joining element |
| 126 | joining surface |
| 128 | component/metal sheet |
| 130 | second joining surface |
| 132 | coating |
| 134 | cleaning device |
| 136 | longitudinal axis |
| 138 | detection device |
| WP | waiting position |
| RP | cleaning position |
| α | angle |
| ys | offset value of slot 52 |

What is claimed is:

1. A joining apparatus for the joining of a joining element to a workpiece on a joining surface, the joining apparatus comprising:
a joining head that defines a joining axis,
a cleaning device for cleaning the joining surface, and
a drive unit for moving the cleaning device in relation to the joining head between a waiting position (WP) and a cleaning position (RP).

2. The joining apparatus according to claim 1, wherein the drive unit is fixed to the joining head.

3. The joining apparatus according to claim 1, wherein the drive unit comprises a linear drive.

4. The joining apparatus according to claim 3, wherein the linear drive comprises a pneumatic cylinder.

5. The joining apparatus according to claim 3, wherein the cleaning device further comprises a housing that is coupled to the linear drive.

6. The joining apparatus according to claim 1, wherein the drive unit comprises a constraining guide for the cleaning device, whereby the cleaning device is moveable on a defined path between the waiting position (WP) and the cleaning position (RP) by means of the constraining guide.

7. The joining apparatus according to claim 6, wherein the constraining guide is shaped to guide cleaning device parallel to the joining axis in some portions of a path between the waiting position and the cleaning position.

8. The joining apparatus according to claim 6, wherein the constraining guide is shaped to guide the cleaning device transversely to the joining axis in some portions of a path between the waiting position and the cleaning position.

9. The joining apparatus according to claim 6, wherein the constraining guide is shaped to guide the cleaning device so that, starting from the waiting position (WP), the cleaning device is first guided parallel to the joining axis, then transversely to the joining axis, and finally again parallel to the joining axis towards the cleaning position (RP).

10. The joining apparatus according to claim 6, wherein the constraining guide comprises a gate slot, which is connected to the joining head, and wherein the constraining guide includes a gate follower connected to the cleaning device and engages the gate slot for movement therein.

11. The joining apparatus of claim 10, wherein the gate slot comprises a serpentine track including a first longitudinal portion and a bend portion.

12. The joining apparatus according toclaim, wherein the gate follower comprises a front gate follower and a rear gate follower spaced axially apart from one another on the cleaning device in a direction substantially parallel to the joining axis and engaging in the gate slot.

13. The joining apparatus according to claim 12, wherein the front gate follower or the rear gate follower is formed by at least one of rollers or bearings.

14. The joining apparatus according to claim 12, wherein an axial spacing between the front gate follower and the rear gate follower is less than a longitudinal extent of a first longitudinal portion of the gate slot.

15. The joining apparatus according to claim 12, wherein an axial spacing between the front gate follower and the rear gate follower is greater than one of (i) a longitudinal extent of a bend portion of the gate slot or (ii) a longitudinal extent of a second longitudinal portion of the gate slot.
